(19) United States
(12) Patent Application Publication
(10) Pub. No.: US 2017/0134365 A1
(43) Pub. Date: May 11, 2017

(54) WIRELESS FIDELITY CONNECTION METHOD AND SYSTEM FOR INTELLIGENT TERMINAL AND ROUTER

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Peng LI, Tianjin (CN)

(21) Appl. No.: 15/249,118

(22) Filed: Aug. 26, 2016

Related U.S. Application Data
(63) Continuation of application No. PCT/CN2016/088404, filed on Jul. 4, 2016.

(30) Foreign Application Priority Data
Nov. 6, 2015 (CN) 201510756771.8

(51) Int. Cl. H04L 29/06; H04W 12/06; H04W 48/16

(52) U.S. Cl. CPC H04L 63/083; H04W 48/16; H04W 12/06

(57) ABSTRACT

An embodiment of the present disclosure discloses a wireless fidelity connection method and a wireless fidelity connection system for an intelligent terminal and a router, wherein the method comprises the following steps: the intelligent terminal monitors a Wi-Fi beacon frame or a Wi-Fi probe response frame which is sent from the router, and determines whether an identification field is carried in the Wi-Fi beacon frame or the Wi-Fi probe response frame; if yes, the intelligent terminal determines whether content of the identification field is identical to content of a preset identification; and if yes, the intelligent terminal employs a Wi-Fi password which is preset in the intelligent terminal to connect the router so as to establish a Wi-Fi connection between the intelligent terminal and the router. The workload of establishing the Wi-Fi connection between the intelligent terminal and the router is reduced, and efficiency of the Wi-Fi connection is increased.

### CROSS-REFERENCE TO RELATED APPLICATIONS

This application is a continuation of International Application No. PCT/CN2016/088404, filed on Jul. 4, 2016, which is based upon and claims priority to Chinese Patent Application No. 201510756771.8, filed on Nov. 6, 2015, the entire contents of all of which are incorporated herein by reference.

### TECHNICAL FIELD

The disclosure relates to the technical field of wireless network, in particular to a wireless fidelity connection method and a wireless fidelity connection system for an intelligent terminal and a router.

### BACKGROUND

Wireless fidelity (Wi-Fi) is a technology for the interconnection of terminals such as personal computers, intelligent equipment (tablet computers, mobile phones, intelligent televisions and the like), wireless routers and the like in a wireless manner. More and more users use Wi-Fi to access Internet on their intelligent equipment. With the development of Internet and Internet of Things, a growing number of equipment has a Wi-Fi networking function.

Because of network security, wireless encryption is set for a majority of Wi-Fi hotspots at present. When the intelligent equipment is connected to a Wi-Fi hotspot for the first time, it is required to manually enter a Wi-Fi password, and a Wi-Fi connection can be established after the password passes authentication. A small number of routers can acquire the Wi-Fi password by means of an NFC (Near Field Communication) technology or QR code scanning and automatically establish a connection with the intelligent equipment. As for complicated Wi-Fi passwords, connection failures occur frequently due to users' wrong password input or lapse of memory. When the routers need to be connected to a large number of pieces of equipment, frequent manual input of Wi-Fi passwords for the connection is inevitably a waste of time and labor force.

### SUMMARY

An embodiment of the present disclosure discloses a wireless fidelity connection method and a wireless fidelity connection system for an intelligent terminal and a router to solve the problem of wasting time and labor force due to the manual input of Wi-Fi passwords.

An embodiment of the present disclosure provides a wireless fidelity connection method for an intelligent terminal and a router, including the following steps:

the intelligent terminal monitors a Wi-Fi beacon frame or a Wi-Fi probe response frame which is sent from the router, and determines whether an identification field is carried in the Wi-Fi beacon frame or the Wi-Fi probe response frame;

if yes, the intelligent terminal determines whether content of the identification field is identical to content of a preset identification;

if yes, the intelligent terminal employs a Wi-Fi password that is preset in the intelligent terminal to connect the router to establish a Wi-Fi connection between the intelligent terminal and the router.

Correspondingly, an embodiment of the present disclosure further provides another wireless fidelity connection method for an intelligent terminal and a router, including the following steps:

the router sends a Wi-Fi beacon frame and a Wi-Fi probe response frame which carries an identification field;

the router compares a Wi-Fi password which is preset in the router with another Wi-Fi password from the intelligent terminal when the intelligent terminal receives the Wi-Fi beacon frame and the Wi-Fi probe response frame which carries the identification field, confirms that content of the identification field is identical to the content of a preset identification, and employs the Wi-Fi password which is preset in the intelligent terminal to connect the router;

if the Wi-Fi password, which is preset in the router, is identical to the Wi-Fi password from the intelligent terminal, the router establishes a Wi-Fi connection with the intelligent terminal.

Correspondingly, an embodiment of the present disclosure further provides a wireless fidelity connection system for an intelligent terminal and a router, including the intelligent terminal and the router, wherein:

the intelligent terminal includes: at least one first processor; and a first memory communicably connected with the at least one first processor for storing instructions executable by the at least one first processor, wherein execution of the instructions by the at least one first processor causes the at least one first processor to:

monitor a Wi-Fi beacon frame or a Wi-Fi probe response frame which is sent from the router, and determine whether an identification field is carried in the Wi-Fi beacon frame or the Wi-Fi probe response frame;

determine whether content of the identification field is identical to content of a preset identification if the identification field is carried in the Wi-Fi beacon frame or the Wi-Fi probe response frame; and

employ a Wi-Fi password which is preset in the intelligent terminal to connect the router so as to establish a Wi-Fi connection between the intelligent terminal and the router if the content of the identification field is identical to the content of the preset identification;

the router includes: at least one second processor; and a second memory communicably connected with the at least one second processor for storing instructions executable by the at least one second processor, wherein execution of the instructions by the at least one second processor causes the at least one second processor to:

send the Wi-Fi beacon frame and the Wi-Fi probe response frame which carries the identification field;

compare a Wi-Fi password which is preset in the router with another Wi-Fi password from the intelligent terminal when the intelligent terminal receives the Wi-Fi beacon frame and the Wi-Fi probe response frame which carries the identification field, confirm that content of the identification field is identical to the content of the preset identification, and employ the Wi-Fi password which is preset in the intelligent terminal to connect the router;

and establish a Wi-Fi connection between the router and the intelligent terminal if the Wi-Fi password, which is preset in the router, is identical to the Wi-Fi password from the intelligent terminal.

Correspondingly, an embodiment of the present disclosure further provides a computer readable storage medium in which a program for the method according to the embodiment of the present disclosure is recorded.

According to the wireless fidelity connection method and the wireless fidelity connection system for the intelligent terminal and the router provided by the embodiment of the present disclosure, a Wi-Fi password is preset in a code of each of the intelligent terminal and the router before leaving the factory; the intelligent terminal determines whether the content of the identification field is identical to the content of the preset identification when enabling a Wi-Fi function and acquiring the Wi-Fi beacon frame or the Wi-Fi probe response frame, which carries the identification field and which was sent from the router; if the content of the identification field is identical to the content of the preset identification, the Wi-Fi connection between the intelligent terminal and the router can be established by employing the Wi-Fi password which is preset in the intelligent terminal; and furthermore, the intelligent terminal employs the preset Wi-Fi password to connect the router. The router compares the preset Wi-Fi password with the Wi-Fi password from the intelligent terminal, and establishes the Wi-Fi connection between the router and the intelligent terminal if the preset Wi-Fi password is identical to the Wi-Fi password from the intelligent terminal. As the Wi-Fi passwords are preset in the intelligent terminal and the router respectively, and the Wi-Fi connection between the intelligent terminal and the router is established by employing the preset Wi-Fi passwords, the operation of manually inputting the Wi-Fi passwords is avoided, the workload of establishing the Wi-Fi connection between the intelligent terminal and the router is reduced, and efficiency of the Wi-Fi connection is increased.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flow chart of a wireless fidelity connection method for an intelligent terminal and a router according to one embodiment of the present disclosure.

FIG. 2 is a structural schematic diagram of a wireless fidelity connection system for an intelligent terminal and a router according to another embodiment of the present disclosure.

FIG. 3 illustrates a block diagram of a computing device used to execute the method according to the present disclosure.

FIG. 4 illustrates a memory cell used to keep or carry a program code for realizing the method according to the present disclosure.

### DETAILED DESCRIPTION

In order to make objects, technical solutions and advantages of the embodiments of the present disclosure apparent, the technical solutions in the embodiments of the present disclosure will be described in a clearly and fully understandable way in connection with the drawings related to the embodiments of the present disclosure. It is obvious that the described embodiments are just a part but not all of the embodiments of the present disclosure. Based on the described embodiments herein, those of ordinary skill in the art can obtain other embodiment(s), without any inventive work, which should be within the scope of the present disclosure.

### First Embodiment

A wireless fidelity connection method for an intelligent terminal and a router provided by an embodiment of the present disclosure will be described in detail.

According to the embodiment, a Wi-Fi password is preset in a code structure of each of the intelligent terminal and the router when leaving the factory; the preset Wi-Fi passwords can establish a Wi-Fi connection at Wi-Fi hotspots of the intelligent terminal and the router; and as the preset Wi-Fi passwords are invisible to users, the security of the Wi-Fi passwords is guaranteed.

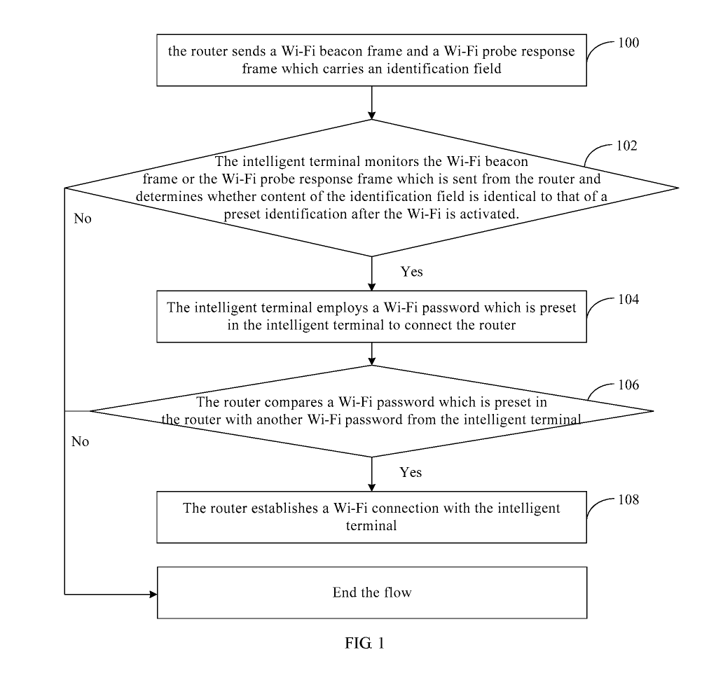

With reference to FIG. 1, which illustrates a step flow chart of a wireless fidelity connection method for an intelligent terminal and a router according to one embodiment of the present disclosure.

Step 100 that the router sends a Wi-Fi beacon frame and a Wi-Fi probe response frame which carries an identification field.

In a preferable embodiment of the present disclosure, the router is set to allow for the employment of a Wi-Fi password that is preset in the router to establish a Wi-Fi connection between the intelligent terminal and the router before the step 100.

If the router is set to not allow for the employment of the Wi-Fi password which is preset in the router to establish the Wi-Fi connection between the intelligent terminal and the router, the connection can only be realized by employing a Wi-Fi password which is configured by a user, wherein the Wi-Fi beacon frame may carry an identification field, and the Wi-Fi probe response frame may also carry the identification field.

Step 102 that the intelligent terminal monitors the Wi-Fi beacon frame or the Wi-Fi probe response frame which is sent from the router, and determines whether content of the identification field is identical to content of a preset identification; if yes, execute step 104; if not, end the flow.

The intelligent terminal reports to a framework of the intelligent terminal when monitoring that the identification field is carried in the Wi-Fi beacon frame or the Wi-Fi probe response frame that is sent from the router and determining that the content of the identification field is identical to the content of the preset identification. The framework will employ the preset Wi-Fi password to connect a Wi-Fi hotspot of the router after receiving the reporting result.

Step 104 that the intelligent terminal employs the Wi-Fi password which is preset in the intelligent terminal to connect the router.

The intelligent terminal may acquire an SSID (Service Set Identifier) of the router from the Wi-Fi beacon frame and employ the preset Wi-Fi password to connect the SSID.

When the intelligent terminal acquires SSIDs of a plurality of routers and all of the SSIDs can be connected by employing the preset Wi-Fi password, the strongest SSID can be selected from Wi-Fi signals to realize the connection.

The intelligent terminal sends to the router a Wi-Fi frame, which carries the identification field, wherein the content of the identification field is the content of the preset identification.

Step 106 that the router compares the Wi-Fi password which is preset in the router with the Wi-Fi password from the intelligent terminal; execute step 108 if the Wi-Fi password which is preset in the router is identical to the Wi-Fi password from the intelligent terminal; end the flow if the Wi-Fi password which is preset in the router is not identical to the Wi-Fi password from the intelligent terminal.

Step 108 that the router establishes the Wi-Fi connection with the intelligent terminal.

According to a preferable embodiment of the present disclosure, both the intelligent terminal and the router are provided with a Wi-Fi password cloud changing interface, and the Wi-Fi passwords, which are preset in the intelligent terminal and the router, can be changed periodically through a cloud server.

In conclusion, according to the wireless fidelity connection method for the intelligent terminal and the router provided by the embodiment of the present disclosure, a Wi-Fi password is preset in a code of each of the intelligent terminal and the router before leaving the factory; the intelligent terminal determines whether the content of the identification field is identical to the content of the preset identification when enabling a Wi-Fi function and acquiring the Wi-Fi beacon frame or the Wi-Fi probe response frame, which carries the identification field and which was sent from the router; if the content of the identification field is identical to the content of the preset identification, the Wi-Fi connection between the intelligent terminal and the router can be established by employing the Wi-Fi password which is preset in the intelligent terminal; and furthermore, the intelligent terminal employs the preset Wi-Fi password to connect the router. The router compares the preset Wi-Fi password with the Wi-Fi password from the intelligent terminal, and establishes the Wi-Fi connection between the router and the intelligent terminal if the preset Wi-Fi password is identical to the Wi-Fi password from the intelligent terminal. As the Wi-Fi passwords are preset in the intelligent terminal and the router respectively, and the Wi-Fi connection between the intelligent terminal and the router is established by employing the preset Wi-Fi passwords, the operation of manually inputting the Wi-Fi passwords is avoided, the workload of establishing the Wi-Fi connection between the intelligent terminal and the router is reduced, and efficiency of the Wi-Fi connection is increased.

### Second Embodiment

A wireless fidelity connection system for an intelligent terminal and a router provided by another embodiment of the present disclosure will be described in detail.

The system includes an intelligent terminal 20 and a router 22. According to the embodiment, a Wi-Fi password is preset in a code structure of each of the intelligent terminal 20 and the router 22 when leaving the factory; and the preset passwords can be employed to establish a Wi-Fi connection between the intelligent terminal 20 and the router 22, wherein the intelligent terminal 20 includes a first determining module 201, a second determining module 202 and a first connecting module 203; and the router 22 includes a frame sending module 221, a comparing module 222 and a second connecting module 223.

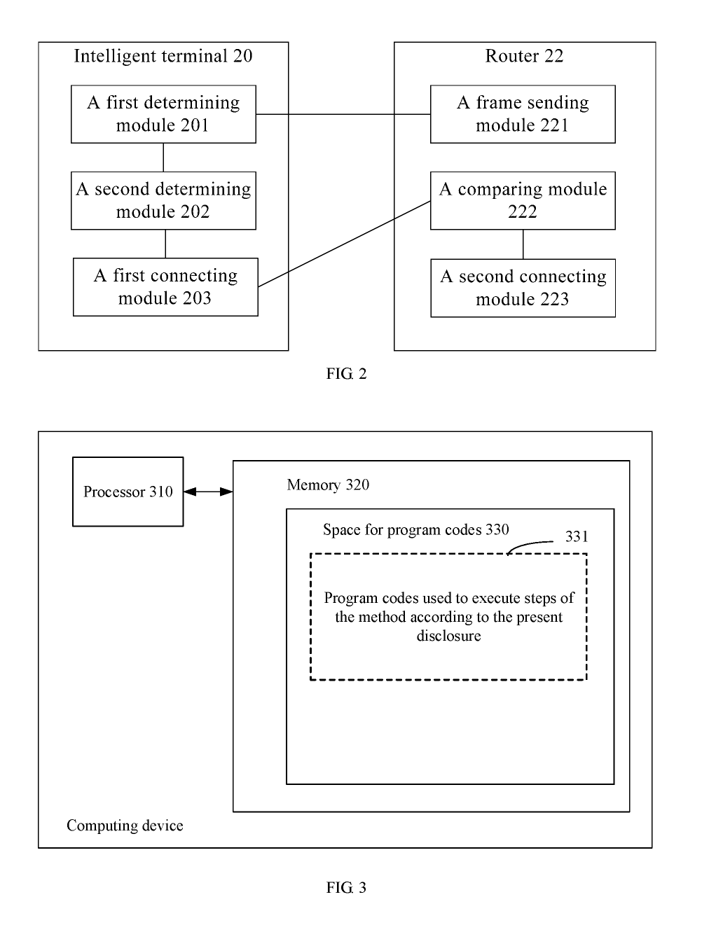

With reference to FIG. 2, which illustrates a structural schematic diagram of a wireless fidelity connection system for an intelligent terminal and a router according to the second embodiment of the present disclosure;

Functions and relationship of the respective modules will be described in detail as follows.

The first determining module 201 is configured to monitor a Wi-Fi beacon frame or a Wi-Fi probe response frame, which is sent from the router, and determines whether an identification field is carried in the Wi-Fi beacon frame or the Wi-Fi probe response frame.

The second determining module 202 is configured to determine whether content of the identification field is identical to content of a preset identification if the identification field is carried in the Wi-Fi beacon frame or the Wi-Fi probe response frame.

The first connecting module 203 is configured to employ a Wi-Fi password that is preset in the intelligent terminal to connect the router to establish a Wi-Fi connection between the intelligent terminal and the router if the content of the identification field is identical to the content of the preset identification.

The frame sending module 221 is configured to send the Wi-Fi beacon frame and the Wi-Fi probe response frame which carries the identification field.

The comparing module 222 is configured to compare a Wi-Fi password which is preset in the router with another Wi-Fi password from the intelligent terminal when the intelligent terminal receives the Wi-Fi beacon frame and the Wi-Fi probe response frame which carries the identification field, confirms that content of the identification field is identical to the content of the preset identification, and employs the Wi-Fi password which is preset in the intelligent terminal to connect the router.

The second connecting module 223 is configured to establish a Wi-Fi connection between the router and the intelligent terminal if the Wi-Fi password, which is preset in the router, is identical to the Wi-Fi password from the intelligent terminal.

Preferably, both the intelligent terminal and the router are provided with a Wi-Fi password cloud changing interface.

According to a preferable embodiment of the present disclosure, the router further includes:

a setting module, which is configured to set the router to allow for the employment of a Wi-Fi password which is preset in the router to establish a Wi-Fi connection before the frame sending module 221 sends the Wi-Fi beacon frame and the Wi-Fi probe response frame which carries the identification field.

In conclusion, according to the wireless fidelity connection system for the intelligent terminal and the router provided by the embodiment of the present disclosure, a Wi-Fi password is preset in a code of each of the intelligent terminal and the router before leaving the factory; the intelligent terminal determines whether the content of the identification field is identical to the content of the preset identification when enabling a Wi-Fi function and acquiring the Wi-Fi beacon frame or the Wi-Fi probe response frame, which carries the identification field and which was sent from the router; if the content of the identification field is identical to the content of the preset identification, the Wi-Fi connection between the intelligent terminal and the router can be established by employing the Wi-Fi password which is preset in the intelligent terminal; and furthermore, the intelligent terminal employs the preset Wi-Fi password to connect the router. The router compares the preset Wi-Fi password with the Wi-Fi password from the intelligent terminal, and establishes the Wi-Fi connection between the router and the intelligent terminal if the preset Wi-Fi password is identical to the Wi-Fi password from the intelligent terminal. As the Wi-Fi passwords are preset in the intelligent terminal and the router respectively, and the Wi-Fi connection between the intelligent terminal and the router is established by employing the preset Wi-Fi passwords, the operation of manually inputting the Wi-Fi passwords is avoided, the workload of establishing the Wi-Fi connection between the intelligent terminal and the router is reduced, and efficiency of the Wi-Fi connection is increased.

Device embodiments described above are illustrative only, wherein the unit described as a separate part may be or may be not physically separated, a part displayed as the unit may be or may be not a physical unit, may be located in one place, or may be distributed on a plurality of network units. Some or all of the modules may be selected to achieve the objective of the solutions of the embodiments according to actual requirements. Those ordinarily skilled in the art may understand and implement it without paying creative works.

Respective device embodiments of the present disclosure may be realized by hardware, software modules which operate on one or more processor(s), or the combination of the hardware and the software modules. Those skilled in the art should understand that some or all functions of some or all components in communication processing equipment according to the embodiment of the present disclosure may be realized by employing a microprocessor or a DSP (Digital Signal Processor) in practice. The present disclosure can also be realized as equipment, a device program (such as a computer program and a computer program product) used to execute a part, or all of the method described herein. According to the present disclosure, the program, which is realized in such a manner, may be stored on a computer readable medium, or may be provided with one or more signal(s). Such signal(s) may be downloaded from a website on the Internet, provided on a carrier signal or provided in any other form.

For example, the device according to the present disclosure may be applied to a computing device, wherein the computing device may include a processor and the computer program product or the computer readable medium in the form of a memory. The memory may be an electronic memory such as a flash memory, an EEPROM (Electrically Erasable Programmable Read-Only Memory), an EPROM (Electrically Programmable Read-Only Memory), hardware or a ROM (Read Only Memory), and is provided with a memory space for program codes used to execute any step of the above methods. For example, the memory space for the program codes may include respective program codes used to realize respective steps in the above-described methods. The program codes may be read from or written into one or more computer program product(s), wherein the computer program products include program code carriers such as hard disks, CDs (Compact Disk), memory cards or floppy disks. Such computer program products are generally portable or fixed memory cells, wherein each of the memory cells may be provided with a memory segment, a storage space and the like in similar arrangement with the memory in the computing device. The program codes may be compressed in an appropriate form. In general, the memory cells include computer readable codes, namely codes that may be read by the above-described processor. Such codes cause the computing device to execute the respective steps of the above-described method when operating on the computing device.

Those ordinarily skilled in the art will appreciate that all or part of steps according to the above method embodiments may be realized by the hardware in connection with a program command, and the above-described program may be stored in a computer readable memory medium. The program executes the steps according to the method embodiments in execution. The memory medium includes respective mediums (such as ROMs, RAMs (Random-Access Memory), diskettes or DVDs (Digital Video Disk) etc. that may store the program codes.

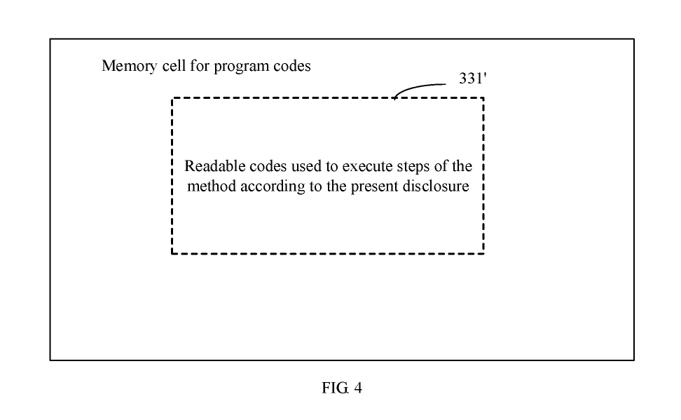

FIG. 3 illustrates a computing device which may realize a regulating method of vehicle information according to the present disclosure. The computing device (such as intelligent terminal, router and the like) conventionally includes a processor 310 and a program product or a readable medium in the form of a memory 320. The memory 320 may be an electronic memory such as a flash memory, an EEPROM (Electrically Erasable Programmable Read-Only Memory), an EPROM (Electrically Programmable Read-Only Memory), or a ROM (Read Only Memory), and is provided with a memory space 330 for program codes 331 used to execute any step of the above methods. For example, the memory space 330 for the program codes may include respective program codes 331 used to realize respective steps in the above-described methods. The program codes may be read from or written into one or more computer program product(s), wherein the computer program products include program code carriers such as memory cards. Such computer program products are generally portable or fixed memory cells as described with reference to FIG. 4, wherein each of the memory cells may be provided with a memory segment, a storage space and the like in similar arrangement with the memory 320 in the computing device as shown in FIG. 3. The program codes may be compressed in an appropriate form. In general, the memory cells include readable codes 331′, namely codes that may be read by the above-described processor 310. Such codes cause the processor of the computing device to execute the respective steps of the above-described method when operating on the processor of the computing device.

Finally, it should be noted that the foregoing embodiments are merely illustrative of technical solutions of the present disclosure without limitation; although the present disclosure is illustrated in detail with reference to the above embodiments, those ordinarily skilled in the art will appreciate that modifications may be made on the technical solutions cited by the above embodiments, or equivalent substitutions may be made on partial technical features; moreover, these modifications or substitutions will not make the essential of corresponding technical solutions depart from the spirit and scope of the technical solutions in respective embodiments of the present disclosure.

What is claimed is:

1. A wireless fidelity connection method for an intelligent terminal and a router, comprising:
the intelligent terminal monitoring a Wi-Fi beacon frame or a Wi-Fi probe response frame which is sent from the router, and determining whether an identification field is carried in the Wi-Fi beacon frame or the Wi-Fi probe response frame;
if yes, the intelligent terminal determining whether content of the identification field is identical to content of a preset identification; and
if yes, the intelligent terminal employing a Wi-Fi password that is preset in the intelligent terminal to connect the router to establish a Wi-Fi connection between the intelligent terminal and the router.

2. The method according to claim 1, wherein the intelligent terminal is provided with a Wi-Fi password cloud changing interface.

3. The method according to claim 1, wherein: the Wi-Fi password is preset in a code structure of the intelligent terminal.

4. A wireless fidelity connection method for an intelligent terminal and a router, comprising:
the router sending a Wi-Fi beacon frame and a Wi-Fi probe response frame which carries an identification field;
the router comparing a Wi-Fi password which is preset in the router with another Wi-Fi password from the intelligent terminal when the intelligent terminal receives the Wi-Fi beacon frame and the Wi-Fi probe response frame which carries the identification field, confirming that content of the identification field is identical to the content of a preset identification, and employing the Wi-Fi password which is preset in the intelligent terminal to connect the router; and
if the Wi-Fi password, which is preset in the router, is identical to the Wi-Fi password from the intelligent terminal, the router establishing a Wi-Fi connection with the intelligent terminal.

5. The method according to claim 4, wherein before the router sends the Wi-Fi beacon frame and the Wi-Fi probe response frame which carries the identification field, the method further comprises:
the router being set to allow for the employment of a Wi-Fi password that is preset in the router to establish a Wi-Fi connection.

6. The method according to claim 4, wherein the router is provided with a Wi-Fi password cloud changing interface.

7. A wireless fidelity connection system for an intelligent terminal and a router, comprising the intelligent terminal and the router, wherein:
the intelligent terminal comprises:
at least one first processor; and
a first memory communicably connected with the at least one first processor for storing instructions executable by the at least one first processor, wherein execution of the instructions by the at least one first processor causes the at least one first processor to:
monitor a Wi-Fi beacon frame or a Wi-Fi probe response frame which is sent from the router, and determine whether an identification field is carried in the Wi-Fi beacon frame or the Wi-Fi probe response frame;
determine whether content of the identification field is identical to content of a preset identification if the identification field is carried in the Wi-Fi beacon frame or the Wi-Fi probe response frame; and
employ a Wi-Fi password which is preset in the intelligent terminal to connect the router so as to establish a Wi-Fi connection between the intelligent terminal and the router if the content of the identification field is identical to the content of the preset identification;
the router comprises:
at least one second processor; and
a second memory communicably connected with the at least one second processor for storing instructions executable by the at least one second processor, wherein execution of the instructions by the at least one second processor causes the at least one second processor to:
send the Wi-Fi beacon frame and the Wi-Fi probe response frame, which carries the identification field;
compare a Wi-Fi password which is preset in the router with another Wi-Fi password from the intelligent terminal when the intelligent terminal receives the Wi-Fi beacon frame and the Wi-Fi probe response frame which carries the identification field, confirm that content of the identification field is identical to the content of the preset identification, and employ the Wi-Fi password which is preset in the intelligent terminal to connect the router; and
establish a Wi-Fi connection between the router and the intelligent terminal if the Wi-Fi password, which is preset in the router, is identical to the Wi-Fi password from the intelligent terminal.

8. The system according to claim 7, wherein both the intelligent terminal and the router are provided with a Wi-Fi password cloud changing interface.

9. The system according to claim 7, wherein execution of the instructions by the at least one second processor further causes the at least one second processor to:
set the router to allow for the employment of a Wi-Fi password which is preset in the router to establish a Wi-Fi connection before the router sends the Wi-Fi beacon frame and the Wi-Fi probe response frame which carries the identification field.
